(19) United States
(12) Patent Application Publication
(10) Pub. No.: US 2008/0157035 A1
(43) Pub. Date: Jul. 3, 2008

(54) Hydrogel Photonic Crystals That Can Be Dehydrated And Re-Hydrated

(75) Inventors: Vladimir L. Alexeev (Deceased), Athens, OH (US); Irina Alexeeva, Athens, OH (US)

Correspondence Address: THE WEBB LAW FIRM, P.C., 700 KOPPERS BUILDING, 436 SEVENTH AVENUE, PITTSBURGH, PA, 15219, US

(73) Assignee: COLLOIDAL MATERIALS, LLC, Pittsburgh, PA (US)

(21) Appl. No.: 11/926,527

(22) Filed: Oct. 29, 2007

Related U.S. Application Data
(60) Provisional application No. 60/855,273, filed on Oct. 30, 2006.

(51) Int. Cl. G02B 5/23

(52) U.S. Cl. 252/586

(57) ABSTRACT

A photonic crystal material comprises an ordered array of nanoscopic particles locked into position by a dehydrated hydrogel matrix. The material can be powdered and used as a colorant. The photonic crystal material has the advantage that its array of nanoscopic particles self assembles for ease in producing a diffractive material that retains these properties when added to other polymers and binders. This material may be added to polymers with ionic content without destroying the array that produces diffraction. The material is easily stored compared to hydrated hydrogels that must be stored in water.

### CROSS REFERENCE TO RELATED APPLICATION

This application claims priority from U.S. Provisional Patent Application No. 60/855,273, filed Oct. 30, 2006, which is incorporated herein by reference.

### STATEMENT REGARDING FEDERALLY SPONSORED RESEARCH

The U.S. Government has a paid-up license in this invention and the right in limited circumstances to require the patent owner to license others on reasonable terms as provided for by the terms of Grant Number 1 R43 DK067788-01A2 awarded by Department of Health and Human Services—National Institutes of Health—National Institute of Diabetes and Digestive and Kidney Diseases.

### BACKGROUND OF THE INVENTION

1. Field of the Invention

The present invention relates generally to a photonic material and a method of creating a photonic material that obtains its color through diffraction. The material is mechanically robust and may be stored in a dehydrated state. The material is chemically robust in that it may be added to other polymers or organic media or aqueous media, with a broad range of pH, without collapse of its diffractive properties. The invention relates to a goniochromatic material that is dehydrated that may be ground into particles that may be used as a “colorant” suitable for use in paint and to color polymers. The invention pertains to colorants that are also biocompatible.

2. Description of Related Art

U.S. Pat. No. 5,281,370 disclosed methods for making a material suitable for narrow band radiation filters. Filtering is achieved by diffraction in which a wavelength band from a broader spectrum is reflected by the material while the remainder of the spectrum is transmitted through the material. The material generally comprises an orderly colloidal structure of nanoscopic particles dispersed in a medium. The colloidal structure is due to self organization driven by the fact that the particles are ionized and of like charge. The method of production determines the diffraction characteristics of the resulting material. Production methods claimed include 1) fusing the particles together by liquefying a medium with a solvent, dispersing the particles in the liquid medium and evaporating the solvent to fuse the surfaces of the particles together; 2) adding ionized particles of the same polarity to a non-ionic liquid monomer (typically acrylamide or bisacrylamide), adding an initiator and polymerizing the monomer around the particles; 3) coating silica particles with a sulfonate, immersing the particles in a liquid medium and allowing them to self-assemble, and then evaporating the medium to create a lattice structure; and 4) immersing electrostatically charged particles in a neutral monomer, applying an electric field to closely pack the particles and polymerizing the monomer around the particles. In each method, the monomer, solvents, and polymerization agents must be non-ionic to allow for self-organization of the particles. The materials resulting from the methods will not be equivalent in their diffraction properties (efficiencies). Method 2 generally provides material with the best diffraction properties and filtering. However, use beyond filters is limited by the monomers, in this patent specifically identified as acrylamide and bisacrylamide which are mechanically weak and have a high percentage water content. These are important shortcomings that limit use. To maintain diffraction, this material must always be stored in water in a sealed container. If dehydrated, the material loses its diffraction properties as there is no mechanism for the colloidal particles to exist as an ordered array. That is, they no longer retain a like charge to cause electrostatic repulsion, the physical force that sets up the ordered array. Additionally, as hydrated acrylamide containing the colloidal array, the material cannot be immersed in or used with an ionic liquid (for instance, a lesser grade monomer containing impurities or an ionic monomer). Under such conditions, the charged colloidal particles may interact with the other ionic species, causing the colloidal particles to become disorganized so as to eliminate diffraction.

U.S. Pat. No. 5,944,994, a continuation-in-part (CIP) of U.S. patent application Ser. No. 08/845,731, filed Jun. 7, 1995, now abandoned, focuses on a coating material that can be used as a paint or nail polish. The coating material claimed contains fragments of a gel membrane filter material that is subjected to “backfilling,” with a polymer selected from acrylamide, N-vinylpyrrolidone, and N,N′-methylene bisacrylamide. Since the particles are closely packed and in contact with each other the film diffracts inefficiently. If the hydrogel becomes dehydrated, the material will also lose diffraction. Thus, the material must be stored in hydrated form. Additionally, U.S. Pat. No. 5,944,994 teaches use of gel membrane colloidal material specifically in paints and nail polishes. The gel membranes are “employed whole or broken into small pieces of at least about 10 microns and mixed with a coating to give the coating refractive properties.”

U.S. Pat. No. 6,123,845, a continuation-in-part (CIP) of U.S. Pat. No. 5,944,994, teaches composition of solid materials suitable for narrow band radiation filters. Filtering is achieved by diffraction in which a wavelength band from a broader spectrum is reflected by the material while the remainder of the spectrum is transmitted through the material. The material generally comprises an orderly colloidal structure of nanoscopic particles dispersed in a medium creating a solid. The colloidal structure self organizes due to the particles being ionized and of like charge. The composition of the material determines diffraction characteristics of the resulting material. These material forms claimed include: 1) a colloidal array wherein adjacent particles are fused together; 2) a colloidal array wherein particles are coated with a polymerizing residue such that adjacent particles are polymerized or “glued” together; 3) a colloidal array wherein particles are dispersed in and surrounded by a polymer solution that is then polymerized; 4) a crystalline ordered array in solid form and comprising a film; 5) a crystalline colloidal array comprising silica particles with charged functional groups on their surface; and 6) a crystalline colloidal array in solid form in which the particles are surrounded by a polymer solution that is polymerized, the polymer solutions comprised of acrylamide and bisacrylamide. Again the particles, in each case, self-assemble due to their charged (ionic) nature. In producing each composition, the monomer, solvents, and polymerization agents must be non-ionic to allow for self-organization of the particles. If dehydrated, the material compositions that require a hydrogel to maintain particle structure lose diffraction properties as there is no mechanism for the colloidal particles to exist as an ordered array. The patent specifically identifies only two polymerizing materials, acrylamide and bisacrylamide. The various compositions are not equivalent in their diffraction properties (efficiencies). The patent refers to the gel membrane colloidal material claimed in U.S. Pat. No. 5,944,994 as suitable for use in paint. It does not associate any of the materials claimed with paint.

U.S. Pat. No. 6,894,086 asserts a possible weakness in the dimensional stability of the material forms described in U.S. Pat. No. 6,123,845 in the presence of water or solvents such that, when used as a colorant in paint, dimensional changes in these materials can cause possibly undesirable changes or inhomogeneities in the perceived color effect. U.S. Pat. No. 6,894,086 thus teaches composition and method to manufacture solid material containing a close-packed colloidal structure not subject to dimensional change. This material is then fragmented for use as a colorant that is added to a carrier to form a “color coating” as taught in U.S. Pat. No. 6,123,845. Diffraction is produced by the discontinuities between the closely packed colloidal particles. Of the various material forms disclosed in U.S. Pat. No. 6,123,845 that contain discontinuities capable of producing diffraction, this close packed arrangement is the least efficient compared to other arrangements in producing vibrant sparkling effects. Of those disclosed, the crystalline colloidal array “surrounded” by a polymer solution rigidized by polymerization provides the most efficient diffraction and would provide the most vivid and sparkling colors. The patent teaches the use of acrylamide and bisacrylamide as polymers to use to form a solid colloidal array. However, as stated earlier, such high water content hydrogels severely limit application. Other polymers might be more suitable for use in this material composition but are not taught in U.S. Pat. No. 6,123,845. Additionally, other compositions taught might have more stability such as an ordered array of colloidal particles wherein the composition is in solid form and are coated with a film of polymerizing residue so adjacent particles are polymerized together.

U.S. Pat. No. 6,894,086 also teaches production of a polymeric color effect colorant comprising: a plurality of particles being essentially free from inorganic material, the particles comprised of a plurality of layers of thermoplastic organic materials including at least five adjacent pairs of layers whose refractive indices differ from each other by at least 0.003. Additionally, it teaches creation of a “coating” by the combination of a film forming component and polymeric color effect colorant. However, the color effects of this method lack vibrancy, having a more pearlescent appearance.

U.S. Pat. No. 7,059,719 teaches use of crystalline colloidal material to provide vibrant sparkling color to cosmetic lenses by Bragg diffraction. The lens includes an annulus of crystalline colloidal material that covers the iris and a clear center that cover the pupil. The patent is not specific on a means to controllably create goniochromatic patterns on portions of the lens to provide structural detail to make for a more naturally appearing iris.

U.S. 2006/0244908-A1 teaches producing cosmetic contact lenses colored by Bragg diffraction using hydrogels commonly used in cosmetic contact lenses and more specifically hydrogels commonly used in contact lenses containing crystalline colloidal arrays.

It would, therefore, be desirable to fabricate, vibrant, sparkling goniochromatic colorants that can be used in a wide variety of applications. Color produced by colorant needs to be predictable when used with various agents associated with the application. The colorant needs to be mixable in both ionic and non-ionic agents. Furthermore, it is desirable that the colorant not be metallic in nature. It is also desirable that the colorant be biocompatible for certain applications, such as, without limitation, coloring cosmetic contact lenses. The colorant (particles) needs to be storable in a dry form that retains the potential to provide vibrant sparkling color.

### SUMMARY OF THE INVENTION

These and other needs are satisfied by the disclosed embodiments that provide for a simple and relatively inexpensive and easy to use material for creating goniochromatic colorants that produce color through a diffraction and reflection process.

The disclosed embodiments comprise a new material and process to diffract light that is usable as a colorant. The material is a dehydrated hydrogel having high polymer content including regularly spaced non-touching spheres, desirably made from polystyrene, with high surface charge, the spacing of these spheres responsible for diffracting light by Bragg diffraction. If “white” light is incident on the material, the wavelength of reflected light is a function of the spacing of the polystyrene spheres and viewing angle. The spheres are locked in place by the high polymer content hydrogel, whether it is hydrated or dehydrated. Desirably, diffraction occurs when the matrix holding the non-touching colloidal particles in place is a dehydrated hydrogel. When hydrated the material diffracts light at a particular wavelength λ1 related to particle spacing when viewed at an angle perpendicular to its surface. When the material is dehydrated, the material shrinks so that the particles are closer together. Consequently, the material now diffracts light such that the reflected light has a shorter wavelength λ2 when viewed at an angle perpendicular to its surface. In both cases, the diffraction efficiency remains high. Additionally, when the dehydrated material is placed in water to cause rehydration, the diffraction occurs at the original wavelength λ1 when viewed at an angle perpendicular to its surface.

When dehydrated, the material may be ground into very small particles that continue to diffract. When the ground material is mixed with a monomer, the particles swell; the monomer may be polymerized such that the particles are fixed in a polymer matrix and will diffract to provide vibrant sparkling color that is a function of viewing angle. Mixing the particles with a solvent produces a paint that provides vibrant sparkling color. Depending on the solvent, the particles may swell. When the paint has dried, the particles will shrink again to their dehydrated state, but retain their ability to diffract.

One embodiment of the invention is a dehydrated hydrogel comprising an ordered array of charged spherical particles, the dehydrated hydrogel having diffractive properties. The hydrogel can have diffractive properties in the visible spectrum, the IR spectrum or the UV spectrum. The hydrogel can have a high polymer content. The polymer can be either hydroxy ethyl methcrylate (HEMA), siloxane or dimethyl acrylamide. Alternatively, the polymer can be a co-polymer of HEMA and siloxane.

The dehydrated hydrogel can be rehydrated. The diffractive properties can change with rehydration.

Another embodiment of the invention is colorant particles comprised of powdered dehydrated hydrogel, the dehydrated hydrogel comprised of an ordered array of charged spherical particles, the dehydrated hydrogel having diffractive properties. The particles can produce color due to diffractive properties.

Another embodiment of the invention is a method of making a article having an ordered array of charged spherical particles. The method includes (a) providing one or more monomers capable of producing a hydrogel of high polymer content; (b) providing a colloidal mixture comprised of like charged particles suspended in a liquid medium; (c) mixing the monomer(s) with the colloidal mixture; (d) polymerizing the mixture of step (c); and (e) dehydrating the polymerized mixture of step (d).

Step (c) can further include mixing a co-solvent, an initiator and a cross-linker with the monomer(s) and the colloidal mixture.

The method can further include converting the dehydrated polymerized mixture into a power. The powered dehydrated mixture can be incorporated into the article. The article can be either a paint, a synthetic fiber, a soft contact lens or a cosmetic.

### BRIEF DESCRIPTION OF THE DRAWINGS

FIG. 1 is a perspective view of a lattice arrangement of monodisperse colloidal particles in a colorant made in accordance with an embodiment of the present invention;

FIG. 2 is a hydrogel that includes the lattice of monodisperse colloidal particles of FIG. 1;

FIG. 3(a) shows a lattice structure of colloidal particles illuminated by “white light” and reflecting light of a specific wavelength λ; and

FIG. 3(b) shows the specificity of the reflected light in FIG. 3(a) comprised of a narrow radiation band around wavelength λ

### DETAILED DESCRIPTION OF THE INVENTION

The embodiment described herein is a high polymer content hydrogel containing an ordered array of non-touching spherical particles that diffract light at a wavelength λ1 at a viewing angle perpendicular to the surface that can be dehydrated and still diffract light, but at a wavelength λ2 where λ1>λ2 at a viewing angle perpendicular to the surface. The material can be rehydrated and will again diffract light at wavelength λ1 at a viewing angle perpendicular to the surface. When dehydrated, the material may be easily stored. Additionally, the material may be ground into a powder of selected particle size. The particles may be used as a colorant that is mixed with various binders to create paint with goniochromatic properties. The powder may also be added to a monomer in which case it will swell; when the mixture is polymerized, the resulting polymer will have a vibrant sparkling color produced by the inclusion of the particles. Again, the observed color is a function of viewing angle.

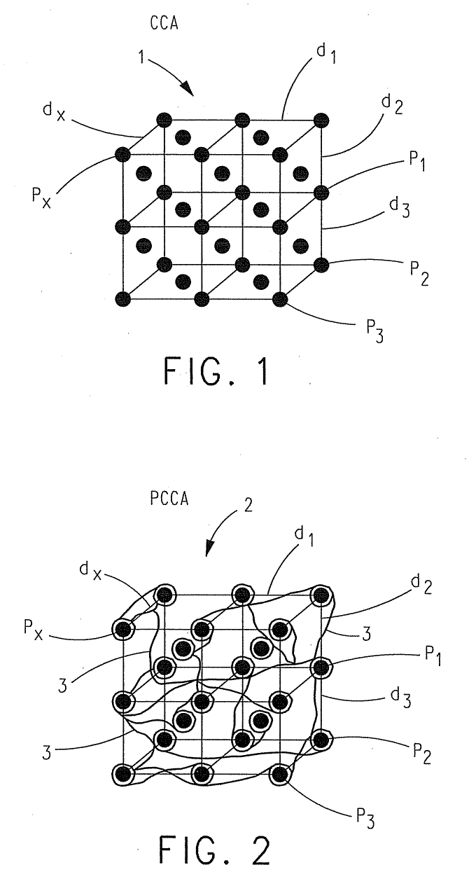

With reference to FIG. 1, the colorant of this embodiment is comprised of a high polymer content hydrogel containing an ordered lattice of spherical particles of same approximate diameter and fixed uniform spacing. Preferably, the lattice self organizes due to like surface charge on each spherical particle. FIG. 1 shows such an arrangement occurring through self ordering in a crystalline colloidal array (CCA). The array includes spherical particles P₁, P₂, P₃, . . . Pₓ, all of the same diameter with like surface charge. The distances between particles d₁, d₂, d₃, . . . dₓ are equal or substantially equal. Each particle P₁, P₂, P₃, . . . Pₓ has the same or substantially the same diameter, desirably, between 50 nanometer and 250 nanometers. The particles P₁, P₂, P₃, . . . Pₓ may be comprised of an organic polymer known in the art (such as polystyrene, polyurethane, polycarbonate, an acrylic polymer, a siloxane polymer, an epoxy-containing polymer, a polymer derived from an epoxy containing polymer), an inorganic polymer known in the art (such as a metal oxide i.e. alumina, silica, or titanium dioxide) or a semiconductor (i.e. cadmium selenide).

Particles P₁, P₂, P₃, . . . Pₓ are generally stored in a dispersion comprising a detergent and relatively small amount of an electrolyte. In this dispersion with other materials, the repelling forces of the like charged particles are mitigated. So, before use, the particles are desirably cleaned of the electrolyte and surfactant impurities by one of various means known in the art.

FIG. 2 shows the polymeric composition 2 after it has been cured. Desirably, the composition is cured by UV or visible light. Particles P₁, P₂, P₃, . . . Pₓ organize in the monomer due to like charge. The distances d₁, d₂, d₃, . . . dₓ between particles P₁, P₂, P₃, . . . Pₓ are equal. Particles P₁, P₂, P₃, . . . Pₓ are now locked in place by the polymer 3 after curing.

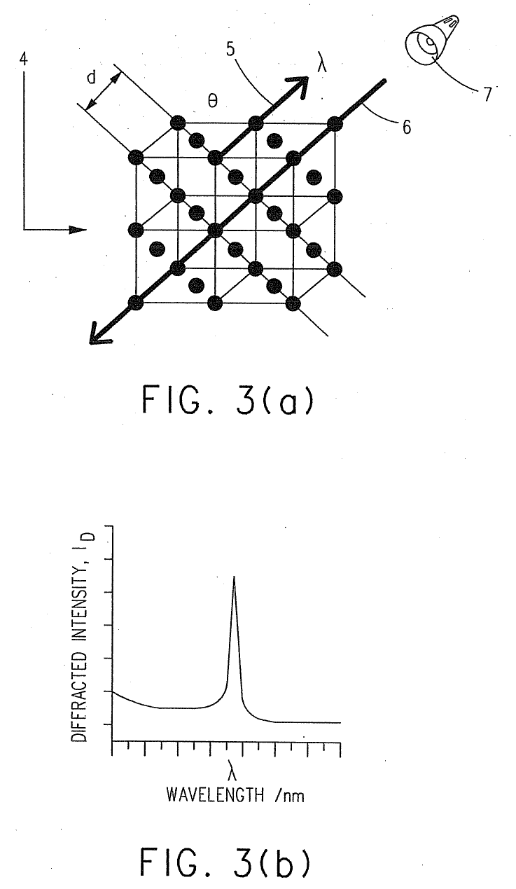

FIG. 3(a) shows the particle lattice arrangement 4 locked in place in by polymerization of a monomer. “White light” source 7 illuminates the particle lattice 4 with incident light beam 6. Light 5 of wavelength λ is reflected at Bragg glancing angle θ while the remainder of the light is transmitted.

Polymerized crystalline colloidal arrays are well known in the art. Various forms have been identified. All utilize spherical particles with high surface charge to self-organize into a uniform lattice arrangement held in place by a polymer matrix. Vibrancy is dependent on form, the close-packed arrangement being the least vibrant. The close packed form in which the like-charged spherical particles are touching has been described in the art for use in paints and nail polish (U.S. Pat. Nos. 5,944,994 and 6,894,086). However, the art has generally focused on low density polymers such as acrylamide, a hydrogel with low polymer content (17%). While diffraction was highly efficient, the material was mechanically weak and had to be kept hydrated to retain diffractive properties. If dehydrated, the material lost it diffractive properties; even rehydration did not revitalize diffraction. These aspects significantly limited use.

The embodiment described herein, when dehydrated, is substantially non-gelatinous and almost transparent. When hydrated, the material is substantially gelatinous and almost transparent. Both the hydrated and dehydrated material are goniochromatic without an undesirable milkiness, which is desirable in color shifting applications. Additionally, the ability to rehydrate the material is also desirable in certain applications.

Below is an exemplary, non-limiting chemical recipe for malting a siloxane-HEMA hydrogel containing an organized colloidal array that is goniochromatic when hydrated or dehydrated. This material reflects a violet color when observed at an angle perpendicular to the surface. When dehydrated, the material shrinks so that the diffraction shifts to the ultraviolet range, causing it to be nearly transparent. When rehydrated, diffraction returns to the same violet color when observed at an angle perpendicular to the surface. The steps to implementing the recipe will be described next:

Chemical components:
monomer 3-(trimethoxysilylpropyl)methacrylate (SiMa)
monomer hydroxyl-ethyl-methacrylate (HEMA), cleaned with aluminum oxide.
cross-linker Ethyleneglycoldimethacrylate (EGDMA), cleaned with aluminum oxide.
initiator diethoxyacetophenone (DEAP)

An exemplary, non-limiting, recipe includes 1.0 g of SiMA, 1.0 g of HEMA, 0.1 g of EGDMA dissolved in 1.0 g of co-solvent diethyleneglycol. The mixture is treated with ion-exchange resin AG 501-X8 mixed bed supplied by BIO RAD.

0.4 g of this mixture is combined with 0.5 g of polystyrene colloid with particle size between 100-170 nm in diameter and with 0.02 g of 10% DEAP in dimethylsulfoxide (DMSO). The mixture is treated with ion exchange resin, spun for 10 minutes and centrifuged for 2 minutes to precipitate ion-exchange resin.

As one method to create a sheet of material, inject between quartz plates and expose to UV light for 15 minutes to polymerize.

The content of 10% DEAP/DMSO can be varied between 0.02-0.05 g without visible changes in appearance.

Instead of EGDMA as a cross-linker, PEG 200 dimethacrylate can be substituted (0.1 g per the previous mixture proportions)

SiMA:HEMA ratio can be 1:1; 10:8; 10:6 without noticeable changes in appearance and properties.

Dehydrate the resulting material by exposing to ambient air. The dehydrated material can then be ground into appropriate sized particles.

The size of the ground particles can be graded for specific uses or applications. These particles can then be viewed as a “colorant” in that they produce color, except that they have no color or contain no dye of their own, but instead reflect a color based on their diffraction properties and viewing angle.

These particles are stable. They can be mixed with other monomers and binders, ionic or non-ionic, and retain highly efficient diffraction properties. These particles can thus be used in a broad array of possible applications.

Application 1. Cosmetic Contact Lenses:

The attractiveness in color shifting in coloring cosmetic lenses has been recognized. The art already address using a hydrogel that provides colored by Bragg diffraction to color shift the color of the iris. However, such an approach may produce an effect that is viewed as unnatural. The manufacturing process requires molding such that the area of the lens over the pupil is clear and appropriately curved while the area over the iris is the color shifting material. However, the embodiment described herein provides an alternative approach. Specifically, the lens may be formed or molded of a hydrogel commonly used in soft contact lenses. Then the ground dehydrated material may be mixed with a binder and applied, e.g., stamped, onto the area of the lens corresponding to the area covering the iris. Additionally, the process of stamping allows establishment of a pattern that is more natural, so that the eye of the wearer is more attractive. The dehydrated material (colorant) made using an appropriate hydrogel facilitates storage, producing colorant particles of the appropriate size to enable stamping natural patterns, and making wear safer and more comfortable. Hydrogels that can be used as the matrix containing the charged spherical particles that form the lattice include, for example, hydroxy ethyl methacrylate (HEMA), siloxane, and dimethylacrylamide, hydrogels already used in the production of soft contact lenses. Note that these are biocompatible.

Application 2. Paint

Color shifting colorant can be used to produce paints. These particles can be used by themselves or included in a binder with particles of pigment. Depending upon the binder, the particles of color shifting colorant may rehydrate and swell; however, as the binder dries on application of the paint, the particles of color shifting colorant will dehydrate and shrink. The dehydrated colorant particles in the dried paint will produce an effect where the color will be vibrant and a function of viewing angle.

Application 3. Synthetic Thread

Particles of color shifting colorant may be added to synthetic material used in making thread for fabric. Again, these may be used by themselves of with particles of pigment. Similarly, as with paint, the particles of colorant may initially rehydrate and swell; however, they will then dehydrate and shrink. The thread will have color that is a function of the colorant content and related to viewing angle.

Application 4. Cosmetics

Particles of color shifting colorant may be added to cosmetics, such as, lipstick, blush, foundation, mascara, eyeliner, etc. to produce therein color that is a function of the colorant content and viewing angle.

The invention has been described with reference to the preferred embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A dehydrated hydrogel comprising an ordered array of charged spherical particles, the dehydrated hydrogel having diffractive properties.

2. The dehydrated hydrogel of claim 1, wherein said hydrogel has diffractive properties in the visible spectrum, the IR spectrum or the UV spectrum.

3. The dehydrated hydrogel of claim 1, wherein said hydrogel has a high polymer content.

4. The dehydrated hydrogel of claim 3, wherein said polymer is either hydroxy ethyl methcrylate (HEMA), siloxane or dimethyl acrylamide.

5. The dehydrated hydrogel of claim 6, wherein said polymer is a co-polymer of HEMA and siloxane.

6. The dehydrated hydrogel of claim 1, wherein said hydrogel is rehydratable.

7. The dehydrated hydrogel of claim 6, wherein the diffractive properties change with rehydration.

8. Colorant particles comprised of powdered dehydrated hydrogel, the dehydrated hydrogel comprised of an ordered array of charged spherical particles, the dehydrated hydrogel having diffractive properties.

9. The colorant particles of claim 8, wherein said particles produce color due to diffractive properties.

10. A method of making an article having an ordered array of charged spherical particles, the method comprising:
(a) providing one or more monomers capable of producing a hydrogel of high polymer content;
(b) providing a colloidal mixture comprised of like charged particles suspended in a liquid medium;
(c) mixing the monomer(s) with the colloidal mixture;
(d) polymerizing the mixture of step (c); and
(e) dehydrating the polymerized mixture of step (d).

11. The method of claim 10, wherein step (c) further includes mixing a co-solvent, an initiator and a cross-linker with the monomer(s) and the colloidal mixture.

12. The method of claim 10, further including converting the dehydrated polymerized mixture into a power.

13. The method of claim 12, further including incorporating the powered dehydrated mixture into the article.

14. The method of claim 10, wherein the article is either a paint, a synthetic fiber, a soft contact lens or a cosmetic.
